(19) United States
(12) Patent Application Publication
(10) Pub. No.: US 2026/0149013 A1
(43) Pub. Date: May 28, 2026

(54) FUEL CELL SYSTEM

(71) Applicant: TOYOTA JIDOSHA KABUSHIKI KAISHA, Toyota-shi (JP)

(72) Inventors: Keitaro YAMAMORI, Toyota-shi (JP); Ryota NAKAMURA, Kariya-shi (JP)

(21) Appl. No.: 19/368,330

(22) Filed: Oct. 24, 2025

(30) Foreign Application Priority Data
Nov. 26, 2024 (JP) 2024-205597

(51) Int. Cl. H01M 8/04089; H01M 8/04111; H01M 8/04746

(52) U.S. Cl. CPC H01M 8/04104; H01M 8/04111; H01M 8/04753; H01M 8/04761

(57) ABSTRACT

A fuel cell system may include a first auxiliary, a second auxiliary and a controller. An operation range or an operation frequency set for the first auxiliary in a first operation mode may be larger than an operation range or an operation frequency set for the first auxiliary in a second operation mode. An operation range or an operation frequency set for the second auxiliary in the first operation mode may be smaller than an operation range or an operation frequency set for the second auxiliary in the second operation mode. The controller may be configured to: execute the first operation mode in a case where a first accumulated operation amount of the first auxiliary is smaller than or equal to a first predetermined amount; and execute the second operation mode in a case where the first accumulated operation amount is larger than the first predetermined amount.

### CROSS REFERENCE TO RELATED APPLICATION

This application claims priority to Japanese Patent Application No. 2024-205597 filed on November 26, 2024. The entire content of the priority application is incorporated herein by reference.

### TECHNICAL FIELD

The art disclosed herein relates to a fuel cell system.

### BACKGROUND

Japanese Patent Application Publication No. 2022-167386 describes a fuel cell system including one or more fluid paths in which a fluid used in the fuel cell system flows; a plurality of auxiliaries disposed at the one or more fluid paths; and a controller configured to control operations of the plurality of auxiliaries.

### SUMMARY

In the fuel cell system of Japanese Patent Application Publication No. 2022-167386, no consideration is given to leveling of loads of the multiple auxiliaries.

The disclosure herein provides a technology allowing for leveling of loads of multiple auxiliaries.

In a first aspect of the present technology, a fuel cell system may comprise: one or more fluid paths in which a fluid used in the fuel cell system flows; a plurality of auxiliaries disposed at the one or more fluid paths; and a controller configured to control operations of the plurality of auxiliaries and selectively execute a first operation mode and a second operation mode. The plurality of auxiliaries may comprise a first auxiliary and a second auxiliary. An operation range or an operation frequency set for the first auxiliary in the first operation mode may be larger than an operation range or an operation frequency set for the first auxiliary in the second operation mode. An operation range or an operation frequency set for the second auxiliary in the first operation mode may be smaller than an operation range or an operation frequency set for the second auxiliary in the second operation mode. The controller may be configured to: execute the first operation mode in a case where a first accumulated operation amount of the first auxiliary is smaller than or equal to a first predetermined amount; and execute the second operation mode in a case where the first accumulated operation amount is larger than the first predetermined amount.

According to the above configuration, the controller executes the second operation mode in response to the first accumulated operation amount exceeding the first predetermined amount. Increasing the operation range or operation frequency set for the second auxiliary in the second operation mode allows for a reduction in the operation range or operation frequency set for the first auxiliary in the second operation mode. As a result, when the second operation mode is executed, the load of the first auxiliary can be reduced and the load of the second auxiliary can be increased. Thus, the loads of multiple auxiliaries can be leveled.

Here, “leveling” means that the difference between the load of the first auxiliary and the load of the second auxiliary is reduced compared to a configuration in which the controller operates only in the first operation mode.

### BRIEF DESCRIPTION OF DRAWINGS

FIG. 1 schematically illustrates a configuration of a fuel cell system 2 according to an embodiment.

FIG. 2 illustrates information stored in a memory 100.

FIG. 3 illustrates a flowchart of an operation mode determination process executed by a controller 10.

### DETAILED DESCRIPTION

In a first aspect of the present technology, a fuel cell system may comprise: one or more fluid paths in which a fluid used in the fuel cell system flows; a plurality of auxiliaries disposed at the one or more fluid paths; and a controller configured to control operations of the plurality of auxiliaries and selectively execute a first operation mode and a second operation mode. The plurality of auxiliaries may comprise a first auxiliary and a second auxiliary. An operation range or an operation frequency set for the first auxiliary in the first operation mode may be larger than an operation range or an operation frequency set for the first auxiliary in the second operation mode. An operation range or an operation frequency set for the second auxiliary in the first operation mode may be smaller than an operation range or an operation frequency set for the second auxiliary in the second operation mode. The controller may be configured to: execute the first operation mode in a case where a first accumulated operation amount of the first auxiliary is smaller than or equal to a first predetermined amount; and execute the second operation mode in a case where the first accumulated operation amount is larger than the first predetermined amount.

In a second aspect according to the first aspect, the fuel cell system may further comprise an air compressor and a fuel cell stack. The one or more fluid paths may comprise a fluid supply path for supplying air from the air compressor to the fuel cell stack; a fluid discharge path for recovering post-reaction air discharged from the fuel cell stack; and a fluid bypass path connecting a first position of the fluid supply path to a second position of the fluid discharge path. The first auxiliary may be a first control valve disposed upstream of the second position of the fluid discharge path, and the second auxiliary may be a second control valve disposed on the fluid bypass path.

The above configuration allows for leveling of the load of the first control valve and the load of the second control valve.

In a third aspect according to the second aspect, the controller may be configured to: execute the second operation mode in a case where the first accumulated operation amount is larger than the first predetermined amount and a second accumulated operation amount of the second auxiliary is smaller than or equal to a second predetermined amount; and execute the first operation mode in a case where the first accumulated operation amount is larger than the first predetermined amount and the second accumulated operation amount is larger than the second predetermined amount.

The above configuration allows the controller to return to the first operation mode at an appropriate timing.

In a fourth aspect according to the second or third aspect, the plurality of auxiliaries may comprise a third control valve disposed downstream of the first position of the fluid supply path. An operation range set for the third control valve in the first operation mode may be larger than an operation range set for the third control valve in the second operation mode

The above configuration allows for leveling of the loads of the first, second, and third control valves.

### (Embodiment)

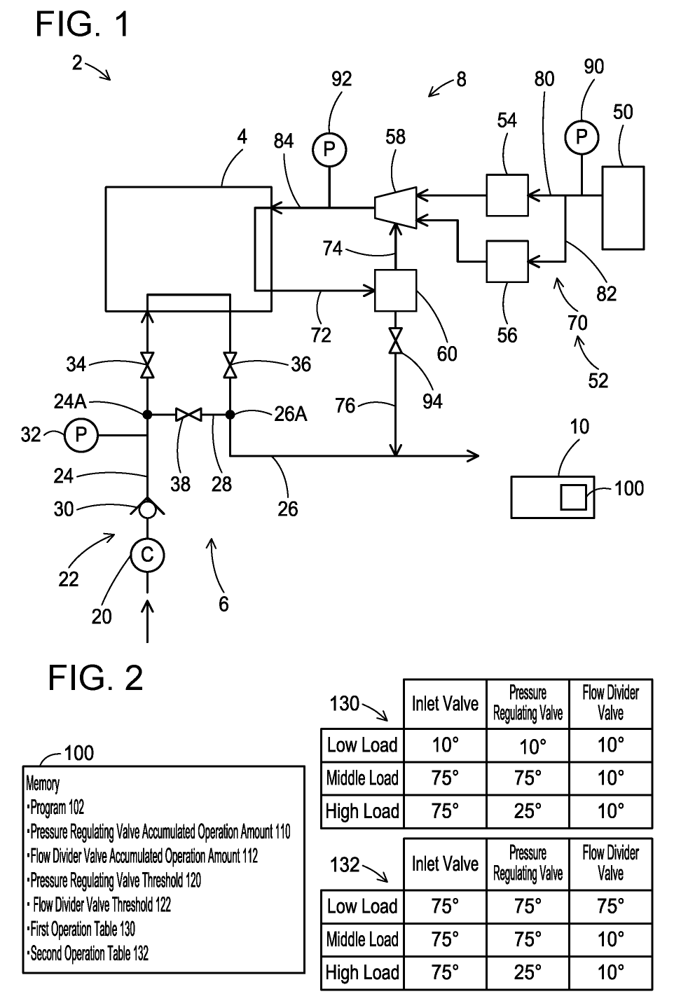

As illustrated in FIG. 1, a fuel cell system 2 comprises a fuel cell stack 4, an air supply system 6 for supplying air as an oxidizing gas, a hydrogen circulation system 8 for supplying a hydrogen gas as a fuel gas, and a controller 10. Although not illustrated, the fuel cell system 2 further comprises a water-cooled cooling system for cooling the fuel cell stack 4. The fuel cell system 2 may comprise an air-cooled cooling system instead of the water-cooled cooling system. The fuel cell stack 4 generates electricity by reacting oxygen contained in the air supplied through the air supply system 6 with hydrogen supplied through the hydrogen circulation system 8. The application of the fuel cell system 2 is not particularly limited. For example, the fuel cell system 2 may be a mobile fuel cell system installed in a mobile body such as a vehicle or a ship, or a stationary fuel cell system used in stationary power generation equipment.

The air supply system 6 comprises an air compressor 20 and an air path 22. The air compressor 20 supplies air containing oxygen to the fuel cell stack 4. The air path 22 comprises an air supply path 24, an air discharge path 26, and a bypass path 28.

Air is supplied from the air compressor 20 to the fuel cell stack 4 through the air supply path 24. The upstream end of the air supply path 24 is connected to the air compressor 20, and the downstream end of the air supply path 24 is connected to the fuel cell stack 4. The air supply path 24 is provided with a check valve 30, a first pressure sensor 32, and an inlet valve 34. The check valve 30 is disposed upstream of the first pressure sensor 32. The first pressure sensor 32 is disposed between the check valve 30 and the inlet valve 34. The inlet valve 34 opens and closes the air supply path 24.

The post-reaction air discharged from the fuel cell stack 4 is recovered through the air discharge path 26. The upstream end of the air discharge path 26 is connected to the fuel cell stack 4, and the downstream end of the air discharge path 26 is connected to a site where the post-reaction air and water are discharged. The air discharge path 26 is provided with a pressure regulating valve 36.

The bypass path 28 connects the air supply path 24 to the air discharge path 26. The bypass path 28 connects a first position 24A of the air supply path 24 to a second position 26A of the air discharge path 26. The first position 24A is located between the first pressure sensor 32 and the inlet valve 34. The second position 26A is located downstream of the pressure regulating valve 36. The bypass path 28 is provided with a flow divider valve 38.

The hydrogen circulation system 8 comprises a fuel tank 50, a hydrogen path 52, an injector 54, a linear solenoid valve (LSV) 56, an ejector 58, and a gas-liquid separator 60. The fuel tank 50 stores a hydrogen gas used as a fuel gas.

The hydrogen path 52 comprises a hydrogen supply path 70, a hydrogen discharge path 72, a circulation path 74, and a gas-water discharge path 76. The hydrogen supply path 70 connects the fuel tank 50 to the fuel cell stack 4. The hydrogen discharge path 72 connects the fuel cell stack 4 to the gas-liquid separator 60. Water generated in the fuel cell stack 4 and exhaust gas are discharged from the fuel cell stack 4 through the hydrogen discharge path 72. Hereinafter, the exhaust gas is termed “fuel off-gas”. The circulation path 74 connects the gas-liquid separator 60 to the ejector 58. The fuel off-gas is supplied to the ejector 58 through the circulation path 74. The gas-water discharge path 76 connects the gas-liquid separator 60 to the air discharge path 26.

The hydrogen supply path 70 comprises a first supply path 80, a second supply path 82 branching off from the first supply path 80, and a third supply path 84. The first supply path 80 and the second supply path 82 each connect the fuel tank 50 to the ejector 58. The first supply path 80 is provided with the injector 54 and a second pressure sensor 90. The injector 54 is located between the bifurcation to the second supply path 82 and the ejector 58. The second pressure sensor 90 is located between the bifurcation to the second supply path 82 and the fuel tank 50. The second pressure sensor 90 detects the pressure in a portion of the path that is upstream of the injector 54 and the LSV 56. The downstream end of the second supply path 82 is connected to the ejector 58. The second supply path 82 is provided with the LSV 56. The third supply path 84 connects the ejector 58 to the fuel cell stack 4. The third supply path 84 is provided with a third pressure sensor 92. The third pressure sensor 92 detects the pressure in a portion of the path that is downstream of the ejector 58. The injector 54 and the LSV 56 adjust an amount of hydrogen gas to be supplied to the fuel cell stack 4. The structures of the injector 54 and the LSV 56 are not particularly limited, and any known injector structure and LSV structure may be used. The ejector 58 draws in the fuel off-gas from the circulation path 74.

The gas-liquid separator 60 is connected to the downstream end of the hydrogen discharge path 72, the upstream end of the circulation path 74, and the upstream end of the gas-water discharge path 76. The gas-water discharge path 76 is provided with a gas-water discharge valve 94.

The controller 10 is configured as a computer comprising a processor and a memory 100 such as a RAM and a ROM. As illustrated in FIG. 2, the memory 100 stores therein a program 102, a pressure regulating valve accumulated operation amount 110, a flow divider valve accumulated operation amount 112, a pressure regulating valve threshold 120, a flow divider valve threshold 122, a first operation table 130, and a second operation table 132.

The controller 10 controls components of the fuel cell system 2 in accordance with the program 102. The controller 10 is connected to the first pressure sensor 32, the second pressure sensor 90, and the third pressure sensor 92. The controller 10 determines a target air volume, a target air pressure, and a target hydrogen volume to be supplied to the fuel cell stack 4 based on information acquired from the sensors 32, 90, 92. The controller 10 controls the injector 54 and the ejector 58 to equalize an air pressure supplied to the fuel cell stack 4 to the target air pressure and equalize an air volume supplied to the fuel cell stack 4 to the target air volume. The controller 10 is configured to selectively execute a first operation mode and a second operation mode as modes for controlling the inlet valve 34, the pressure regulating valve 36, and the flow divider valve 38. Additionally, the controller 10 controls the air compressor 20, the inlet valve 34, the pressure regulating valve 36, and the flow divider valve 38 to equalize a hydrogen volume supplied to the fuel cell stack 4 to the target hydrogen volume.

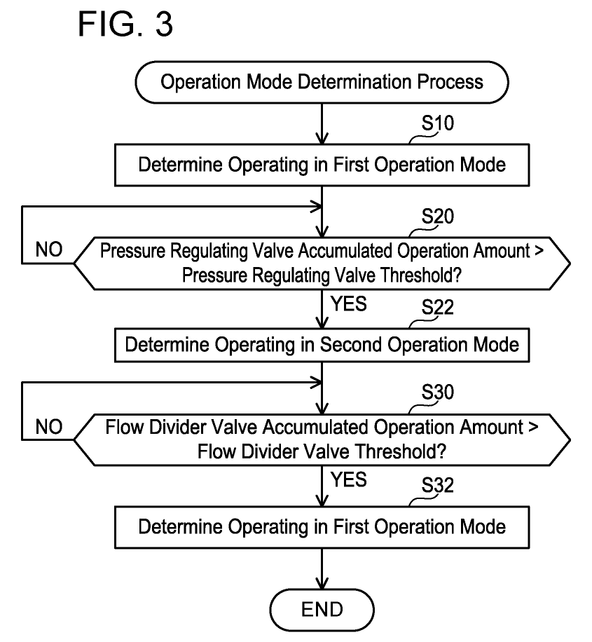

The pressure regulating valve accumulated operation amount 110, the flow divider valve accumulated operation amount 112, the pressure regulating valve threshold 120, and the flow divider valve threshold 122 are all information used in an operation mode determination process, which will be described below (see FIG. 3). The pressure regulating valve accumulated operation amount 110 indicates an accumulated operation amount of the pressure regulating valve 36. Specifically, the pressure regulating valve accumulated operation amount 110 indicates an accumulated value of opening angles of the pressure regulating valve 36. The flow divider valve accumulated operation amount 112 indicates an accumulated operation amount of the flow divider valve 38. Specifically, the flow divider valve accumulated operation amount 112 indicates an accumulated value of opening angles of the flow divider valve 38. The pressure regulating valve threshold 120 and the flow divider valve threshold 122 are thresholds used for switching between the operation modes. In an example, the pressure regulating valve threshold 120 is a value obtained by multiplying the upper limit for operation amount of the pressure regulating valve 36 by “0.7”. The upper limit for operation amount of the pressure regulating valve 36 is determined by a durability test, etc. In an example, the flow divider valve threshold 122 is a value obtained by multiplying the upper limit for operation amount of the flow divider valve 38 by “0.7”. The upper limit for operation amount of the flow divider valve 38 is determined by a durability test, etc.

The first operation table 130 and the second operation table 132 correspond to the first operation mode and the second operation mode, respectively. The first operation table 130 and the second operation table 132 each indicate operation details of the inlet valve 34, the pressure regulating valve 36, and the flow divider valve 38. The operation details are operation ranges of the inlet valve 34, the pressure regulating valve 36, and the flow divider valve 38. In each of the first operation table 130 and the second operation table 132, opening angles of each valve for a low-load region, a medium-load region, and a high-load region are set. The low-load region is an area where the required power generation is relatively small. The high-load region is an area where the required power generation is relatively large. The medium-load region is an area between the low-load region and the high-load region.

First, the contents of the first operation table 130 are described. The opening angles of the inlet valve 34 are set as “10°”, “75°”, and “75°” for the low-load region, the medium-load region, and the high-load region, respectively. The opening angles of the pressure regulating valve 36 are set as “10°”, “75°”, and “25°” for the low-load region, the medium-load region, and the high-load region, respectively. The opening angles of the flow divider valve 38 are set as “10°”, “10°”, and “10°” for the low-load region, the medium-load region, and the high-load region, respectively. As above, in the first operation table 130, the operation range of the pressure regulating valve 36 is larger than that of the flow divider valve 38. In contrast, the operation range of the pressure regulating valve 36 is the same as that of the inlet valve 34. However, the operation frequency of the pressure regulating valve 36 is higher than that of the flow divider valve 38.

Next, the contents of the second operation table 132 are described. The opening angles of the inlet valve 34 are set as “75°”, “75°”, and “75°” for the low-load region, the medium-load region, and the high-load region, respectively. The opening angles of the pressure regulating valve 36 are set as “75°”, “75°”, and “25°” for the low-load region, the medium-load region, and the high-load region, respectively. The opening angles of the flow divider valve 38 are set as “75°”, “10°”, and “10°” for the low-load region, the medium-load region, and the high-load region, respectively. As above, in the second operation table 132, the operation range of the flow divider valve 38 is larger than that of the pressure regulating valve 36. Additionally, the operation range of the pressure regulating valve 36 is larger than that of the inlet valve 34.

Characteristics of the contents in the first operation table 130 and the second operation table 132 are summarized as follows. The operation range set for the pressure regulating valve 36 in the first operation table 130 is larger than the operation range set for the pressure regulating valve 36 in the second operation table 132. Furthermore, the operation range set for the flow divider valve 38 in the first operation table 130 is smaller than the operation range set for the flow divider valve 38 in the second operation table 132. Additionally, the operation range set for the inlet valve 34 in the first operation table 130 is larger than the operation range set for the inlet valve 34 in the second operation table 132.

### (Operation Mode Determination Process: FIG. 3)

Referring to FIG. 3, an operation mode determination process executed by the controller 10 of the fuel cell system 2 is described.

In S10, the controller 10 determines to operate in the first operation mode. That is, the controller 10 determines to control the inlet valve 34, the pressure regulating valve 36, and the flow divider valve 38 according to the first operation table 130 in the memory 100. When S10 is completed, the controller 10 proceeds to S20.

In S20, the controller 10 monitors whether the pressure regulating valve accumulated operation amount 110 in the memory 100 exceeds the pressure regulating valve threshold 120 in the memory 100. In case the pressure regulating valve accumulated operation amount 110 exceeds the pressure regulating valve threshold 120, the controller 10 makes a determination of YES in S20 and proceeds to S22.

In S22, the controller 10 determines to operate in the second operation mode. That is, the controller 10 determines to control the inlet valve 34, the pressure regulating valve 36, and the flow divider valve 38 according to the second operation table 132 in the memory 100. When S22 is completed, the controller 10 proceeds to S30. That is, the controller 10 keeps operating in the first operation mode until the pressure regulating valve accumulated operation amount 110 exceeds the pressure regulating valve threshold 120.

In S30, the controller 10 monitors whether the flow divider valve accumulated operation amount 112 in the memory 100 exceeds the flow divider valve threshold 122 in the memory 100. In case the flow divider valve accumulated operation amount 112 exceeds the flow divider valve threshold 122, the controller 10 makes a determination of YES in S30 and proceeds to S32.

In S32, the controller 10 determines to operate in the first operation mode. When S32 is completed, the controller 10 terminates the process of FIG. 3. After terminating the process of FIG. 3, the controller 10 keeps operating in the first operation mode until the fuel cell system 2 is turned off. That is, the controller 10 operates in the second operation mode from when the pressure regulating valve accumulated operation amount 110 exceeds the pressure regulating valve threshold 120 to when the flow divider valve accumulated operation amount 112 exceeds the flow divider valve threshold 122. Then, the controller 10 operates in the first operation mode after the pressure regulating valve accumulated operation amount 110 exceeds the pressure regulating valve threshold 120 and the flow divider valve accumulated operation amount 112 exceeds the flow divider valve threshold 122.

Hereinafter, the inlet valve 34, the pressure regulating valve 36, and the flow divider valve 38 may be termed “a plurality of (or multiple) auxiliaries”.

As described above, the fuel cell system 2 comprises the air path 22 through which air used in the fuel cell system 2 flows, the plurality of auxiliaries disposed at the air path 22, and the controller 10 configured to control the operations of the multiple auxiliaries and selectively execute the first operation mode and the second operation mode. The multiple auxiliaries comprise the pressure regulating valve 36 (an example of “first auxiliary”) and the flow divider valve 38 (an example of “second auxiliary”). The operation range set for the pressure regulating valve 36 in the first operation mode is larger than the operation range set for the pressure regulating valve 36 in the second operation mode. The operation range set for the flow divider valve 38 in the first operation mode is smaller than the operation range set for the flow divider valve 38 in the second operation mode. The controller 10 is configured to execute the first operation mode (S10) in case the pressure regulating valve accumulated operation amount 110 (an example of “first accumulated operation amount”) is smaller than or equal to the pressure regulating valve threshold 120 (an example of “first predetermined amount”) (NO in S20 of FIG. 3), and execute the second operation mode (S22) in case the pressure regulating valve accumulated operation amount 110 exceeds the pressure regulating valve threshold 120 (YES in S20).

According to the above configuration, the controller 10 executes the second operation mode in response to the pressure regulating valve accumulated operation amount 110 exceeding the pressure regulating valve threshold 120. Increasing the operation range set for the flow divider valve 38 in the second operation mode allows for a reduction in the operation range set for the pressure regulating valve 36 in the second operation mode. As a result, when the second operation mode is executed, the load of the pressure regulating valve 36 can be reduced and the load of the flow divider valve 38 can be increased. Thus, the loads of the multiple auxiliaries can be leveled.

In particular, in this embodiment, the load of the pressure regulating valve 36 in the first operation mode is greater than the load of the flow divider valve 38 in the first operation mode. In contrast, the load of the pressure regulating valve 36 in the second operation mode is smaller than the load of the flow divider valve 38 in the second operation mode. Thus, the loads of the pressure regulating valve 36 and the flow divider valve 38 can be leveled.

Furthermore, the fuel cell system 2 further comprises the air compressor 20 and the fuel cell stack 4. The air path 22 comprises the air supply path 24 (an example of “fluid supply path”) for supplying air from the air compressor 20 to the fuel cell stack 4, the air discharge path 26 (an example of “fluid discharge path”) for recovering the post-reaction air discharged from the fuel cell stack 4, and the bypass path 28 connecting the first position 24A of the air supply path 24 to the second position 26A of the air discharge path 26. The pressure regulating valve 36 (an example of “first control valve”) is disposed upstream of the second position 26A of the air discharge path 26, and the flow divider valve 38 (an example of “second control valve”) is disposed on the bypass path 28.

The above configuration allows for leveling of the loads of the pressure regulating valve 36 and the flow divider valve 38.

Furthermore, the controller 10 is configured to execute the second operation mode (S22) in case the pressure regulating valve accumulated operation amount 110 exceeds the pressure regulating valve threshold 120 and the flow divider valve accumulated operation amount 112 (an example of “second accumulated operation amount”) of the flow divider valve 38 is smaller than or equal to the flow divider valve threshold 122 (an example of “second predetermined amount”) (NO in S30), and execute the first operation mode (S32) in case the pressure regulating valve accumulated operation amount 110 exceeds the pressure regulating valve threshold 120 and the flow divider valve accumulated operation amount 112 exceeds the flow divider valve threshold 122 (YES in S30).

The above configuration allows the controller 10 to return to the first operation mode at an appropriate timing.

Additionally, the multiple auxiliaries comprise the inlet valve 34 (an example of “third control valve”) disposed downstream of the first position 24A of the air supply path 24. The operation range set for the inlet valve 34 in the first operation mode is larger than the operation range set for the inlet valve 34 in the second operation mode.

The above configuration allows for leveling of the loads of the flow divider valve 38 and the inlet valve 34.

The embodiments have been described in detail above. However, these are only examples and do not limit the claims. The technology described in the claims includes various modifications and changes of the concrete examples represented above.

(First Modification) In the above embodiment, the controller 10 changes the operation ranges of the inlet valve 34, the pressure regulating valve 36, and the flow divider valve 38 between the first operation mode and the second operation mode. In a modification, the controller 10 may change the operation frequencies of the injector 54 and the LSV 56 between the first operation mode and the second operation mode. In this modification, the memory 100 of the controller 10 stores an injector accumulated operation amount, an LSV accumulated operation amount, an injector threshold, and an LSV threshold. The injector accumulated operation amount indicates an accumulated operation amount (e.g., the number of operations) of the injector 54. The LSV accumulated operation amount indicates an accumulated operation amount (e.g., the number of operations) of the LSV 56. In an example, the injector threshold and the LSV threshold are a value obtained by multiplying the upper limit for operation amount of the injector 54 by “0.7” and a value obtained by multiplying the upper limit for operation amount of the LSV 56 by “0.7”, respectively. The upper limit for operation amount of the injector 54 and the upper limit for operation amount of the LSV 56 are determined by durability tests, etc.

The controller 10 actuates the injector 54 for the low-load region in the first operation mode and actuates the LSV 56 for the medium-load region and the high-load region in the first operation mode. The fuel cell system 2 is expected to operate more frequently for the low load region than it operates for the medium load region and the high load region. In this case, the operation frequency of the injector 54 is higher than that of the LSV 56. That is, in the first operation mode, the load of the injector 54 is greater than the load of the LSV 56.

In view of the above, in this modification, the controller 10 actuates the injector 54 and the LSV 56 for the low-load region in the second operation mode, and actuates the LSV 56 for the medium-load region and the high-load region in the second operation mode. Both the injector 54 and the LSV 56 operating for the low-load region can reduce the operation frequency of the injector 54 for the low-load region compared to a configuration where the injector 54 operates alone for the low-load region. Additionally, since the LSV56 operates for the low-load region, the medium-load region, and the high-load region, the operation frequency of the LSV56 is increased. This configuration allows for leveling of the loads of the injector 54 and the LSV56.

In this modification, the hydrogen gas is an example of “fluid”. The hydrogen path 52 is an example of “one or more fluid paths”. The injector 54 and the LSV 56 are an example of “a plurality of auxiliaries”. The injector 54 and the LSV 56 are examples of “first auxiliary” and “second auxiliary”, respectively.

In another modification, the controller 10 may change the operations of the inlet valve 34, the pressure regulating valve 36, the flow divider valve 38, the injector 54, and the LSV 56 between the first operation mode and the second operation mode.

(Second Modification) S30 and S32 in FIG. 3 may be omitted. In this modification, the controller 10 operates in the second operation mode after making the determination of YES in S20.

(Third Modification) The operation of the inlet valve 34 in the first operation mode may be the same as the operation of the inlet valve 34 in the second operation mode.

The technical elements explained in the present description or drawings exert technical utility independently or in combination of some of them, and the combination is not limited to one described in the claims as filed. Moreover, the technology exemplified in the present description or drawings achieves a plurality of objects at the same time, and has technical utility by achieving one of such objects.

What is claimed is:

1. A fuel cell system comprising:
one or more fluid paths in which a fluid used in the fuel cell system flows;
a plurality of auxiliaries disposed at the one or more fluid paths; and
a controller configured to control operations of the plurality of auxiliaries and selectively execute a first operation mode and a second operation mode,
wherein the plurality of auxiliaries comprises a first auxiliary and a second auxiliary,
an operation range or an operation frequency set for the first auxiliary in the first operation mode is larger than an operation range or an operation frequency set for the first auxiliary in the second operation mode, and
an operation range or an operation frequency set for the second auxiliary in the first operation mode is smaller than an operation range or an operation frequency set for the second auxiliary in the second operation mode, and
the controller is configured to:
execute the first operation mode in a case where a first accumulated operation amount of the first auxiliary is smaller than or equal to a first predetermined amount; and
execute the second operation mode in a case where the first accumulated operation amount is larger than the first predetermined amount.

2. The fuel cell system as in claim 1, further comprising:
an air compressor; and
a fuel cell stack,
wherein the one or more fluid paths comprise:
a fluid supply path for supplying air from the air compressor to the fuel cell stack;
a fluid discharge path for recovering post-reaction air discharged from the fuel cell stack; and
a fluid bypass path connecting a first position of the fluid supply path to a second position of the fluid discharge path,
the first auxiliary is a first control valve disposed upstream of the second position of the fluid discharge path, and
the second auxiliary is a second control valve disposed on the fluid bypass path.

3. The fuel cell system as in claim 2, wherein the controller is configured to:
execute the second operation mode in a case where the first accumulated operation amount is larger than the first predetermined amount and a second accumulated operation amount of the second auxiliary is smaller than or equal to a second predetermined amount; and
execute the first operation mode in a case where the first accumulated operation amount is larger than the first predetermined amount and the second accumulated operation amount is larger than the second predetermined amount.

4. The fuel cell system as in claim 2, wherein the plurality of auxiliaries comprises a third control valve disposed downstream of the first position of the fluid supply path, and
an operation range set for the third control valve in the first operation mode is larger than an operation range set for the third control valve in the second operation mode.
